(19) United States
(12) Patent Application Publication
(10) Pub. No.: US 2008/0202358 A1
(43) Pub. Date: Aug. 28, 2008

(54) Pressing and Heating System for Pressing of a Multilayer Press Assembly

(75) Inventor: Dieter Backhaus, Sexau (DE)

Correspondence Address: LERNER GREENBERG STEMER LLP, P O BOX 2480, HOLLYWOOD, FL, 33022-2480, US

(73) Assignee: Monika Backhaus, Sexau (DE)

(21) Appl. No.: 12/039,406

(22) Filed: Feb. 28, 2008

(30) Foreign Application Priority Data
Feb. 28, 2007 (DE) 10 2007 010 079.7
Nov. 12, 2007 (DE) 10 2007 054 171.8

(51) Int. Cl. B30B 15/34; B30B 15/26

(52) U.S. Cl. 100/43; 100/319

(57) ABSTRACT

A pressing and heating system for pressing of a multilayer press assembly in which the multilayer press assembly may have a plurality of multilayer sets of material, for fabrication of printed circuit boards or the like, which are mutually separated by at least one separating plate. The system contains at least one tool that is to be inserted in an insertion opening of a stacked press. The tool being of a form that is electrically heatable, for the purpose of which heating at least one electrically powered heating element is provided, and the system further contains a control unit for controlling the heating element. With the aim of improving such a system, at least one thermocouple element is provided.

### CROSS-REFERENCE TO RELATED APPLICATIONS

This application claims the priority, under 35 U.S.C. §119, of German applications DE 10 2007 010 079.7, filed Feb. 28, 2007 and DE 10 2007 054 171.8, filed Nov. 12, 2007; the prior application is herewith incorporated by reference in its entirety.

### BACKGROUND OF THE INVENTION

### FIELD OF THE INVENTION

The invention relates to a pressing and heating system for pressing of a multilayer press assembly. The multilayer press assembly has a plurality of multilayer sets of material being mutually separated by at least one separating plate. The pressing and heating system contains a stacked press having an insertion opening, at least one electrically powered heating element, and at least one tool for inserting into the insertion opening of the stacked press. The tool is electrically heatable by the electrically powered heating element. A control unit is provided for controlling the heating element.

In the state of the art, a variety of configurations of tools, and a variety of press assembly arrangements, for the pressing of multilayer printed circuit boards (or the like) are known. The pressing of the multilayer sets of material (for the printed circuit boards) is generally carried out in a stacked press under vacuum, wherewith the layers of the respective multilayer sets are pressed together at for example 180° C.

In general, one begins with establishment of a press assembly arrangement which will be disposed in the press. Two press plates are employed, designated press tools, and the elements of the multilayer sets of material (for the printed circuit boards) are stacked between press pads, which sets are mutually separated by separating plates. Each multilayer set of material (for a multilayer printed circuit board) has a plurality of layers, namely has a plurality of interior layers and prepreg layers with copper film laminated thereon on both sides. The resulting press assembly structure is then inserted into a press.

Published, non-prosecuted German patent application DE 10 2005 034 499 A describes a press assembly arrangement which has a press tool formed of three individual tools, each of which tools is electrically heatable. This press assembly arrangement can be inserted into the opening of a stacked press. Thus a pressing and heating system is described which represents a substantial improvement over the previously known state of the art for methods and apparatuses for pressing of multilayer press assemblies. However, additional improvements are possible and would be desirable.

### BRIEF SUMMARY OF THE INVENTION

It is accordingly an object of the invention to provide a pressing and heating system for pressing of a multilayer press assembly that overcomes the above-mentioned disadvantages of the prior art devices of this general type, which enables improved fabrication of multilayer printed circuit boards and the like, particularly optimal energy economies, labor savings, and savings in fabrication costs, for multilayer printed circuit boards and the like.

With the foregoing and other objects in view there is provided, in accordance with the invention, a pressing and heating system for pressing of a multilayer press assembly, the multilayer press assembly having a plurality of multilayer sets of material being mutually separated by at least one separating plate. The pressing and heating system contains a stacked press having an insertion opening, at least one electrically powered heating element, at least one thermocouple element, and at least one tool for being inserted into the insertion opening of the stacked press. The tool is electrically heatable by the at least one electrically powered heating element. A control unit is provided for controlling the heating element.

The problem is solved according to the invention in that at least one thermocouple or the like is provided. By provision of one or more sensors for determining the temperature, such sensors containing in particular thermocouples, one can appreciably improve the overall pressing and heating process for fabricating the multilayer printed circuit boards or the like. In particular, by provision of suitable control measures, the electrically heatable tools may be controlled such that the pressing, warming (heat-up), and heating processes can be optimally controlled with respect to each other. High energy savings can be achieved, and costs in time, labor, and associated costs, can be further reduced. Thus the attendant advantages are substantial.

The above-stated problem is further solved in that the first connecting terminals and/or the associated contact connectors are configured such that, when the tools and/or the press assembly configuration is/are inserted into the opening of the press, a possible difference in height between the first connecting terminals and the contact connectors can be automatically compensated for, so that the first connecting terminals can be contacted with the contact connectors. It is quite possible for differences in height to come about when setting up a multilayer press assembly, particularly a press assembly formed of a plurality of sets of layers of material to be pressed, in a so-called press assembly configuration which includes the tools, wherewith among the reasons for such differences in height are manufacturing tolerances in fabrication of the separation plates or the multilayer sets of material themselves. This solution of providing measures for accommodating differences in height avoids the need for extensive refitting or replacement which can be inconvenient and costly, with the added costs including labor costs, and enables insertion of the press assembly configuration tools in the opening of a press without problems, and, without additional labor costs, enables achievement of optimal contacting of the connecting terminals of the heating elements with the corresponding contact connectors on the press. Not only are labor costs saved, but the time required to set up the press for a given operation is minimized.

In accordance with an added feature of the invention, the thermocouple element is disposed inside the tool. Preferably, the thermocouple element is one of at least three thermocouple elements and the tool is one of three tools that are insertable into the insertion opening of the stacked press, and each of the tools has a respective one of the thermocouple elements.

In accordance with an additional feature of the invention, the tool includes a cover plate, a heat transfer plate and the heating element is disposed between the cover plate and the heat transfer plate. Optionally, the tool includes two heat transfer plates and the heating element is disposed between the two heat transfer plates.

In accordance with a further feature of the invention, the heating element is a flattish heating body with a micanite coating on at least two sides.

In accordance with another feature of the invention, the three tools define a press assembly configuration having an upper tool and a lower tool constructed and disposable in relation to the at least one multilayer press assembly. At least the upper and lower tools are capable of being inserted and utilized in the insertion opening of the stacked press. The press assembly configuration further includes a middle tool disposed generally in a middle of the press assembly configuration.

In accordance with yet another feature of the invention, the thermocouple element is disposed in the multilayer press assembly.

In accordance with another added feature of the invention, the heating element is one of three heating elements and each of the heating elements is part of one of the tools. The stacked press has first contact connectors and second sensor connectors and at least one of the heating elements and the tools have first electrical connecting terminals for connecting with corresponding ones of the first contact connectors of the stacked press. The thermocouple elements have corresponding second connecting terminals for connecting with corresponding ones of the second sensor connectors of the stacked press. Ideally, at least one of the first and second connecting terminals are plug connectors.

With the foregoing and other objects in view there is provided, in accordance with the invention, a pressing and heating system for pressing at least one multilayer press assembly formed of multilayer sets of material. The pressing and heating system includes a press assembly configuration containing electrically heatable tools having first connecting terminals, heating elements having first connecting terminals, and a press for at least one of pressing and fabricating the at least one multilayer press assembly. The press has an opening for allowing insertion of the multilayer press assembly and insertion of the electrically heatable tools. The press has electrical contact connectors for receiving the first connecting terminals of the heating elements and/or the tools. At least one of the first connecting terminals and the electrical contact connectors are configured such that, when at least one of the tools or the press assembly configuration is inserted into the opening of the press, a possible difference in height between the first connecting terminals and the electrical contact connectors can be automatically compensated for, so that the first connecting terminals can be contacted with the electrical contact connectors.

In accordance with an added feature of the invention, thermocouple elements having second connecting terminals are provided. The press has sensor connectors each provided for a corresponding one of the thermocouple elements, the second connecting terminals and corresponding ones of the sensor connectors are configured such that, when at least one of the tools and the press assembly configuration is inserted in the opening of the press, a possible difference in height between the second connecting terminals and the sensor connectors can be automatically compensated for, so that the second connecting terminals can be contacted with the sensor connectors.

In accordance with a preferred embodiment of the invention, the electrical contact connectors and/or the sensor connectors are realizable in a contact strip. Ideally, the electrical contact connectors, the sensor connectors and/or the contact strip is disposed at a rear wall of the opening of the press. Optionally, the first and second connecting terminals, the electrical contact connectors and the sensor connectors are in the form of sliding contact sets which automatically compensate for height differences. Furthermore, the first and second connecting terminals, the electrical contact connectors and the sensor connectors may have at least partly tapered regions and/or spring-loaded contact elements, for automatic compensation for possible height differences between the first and second connecting terminals, and the electrical contact connectors and the sensor connectors. Additionally, the first and/or second connecting terminals have a contact point configuration. Ideally, the contact point configuration is a knob-shaped configuration.

In accordance with another feature of the invention, each of the tools has a connecting block for bearing and accommodating the first and/or second connecting terminals. Each of the connecting blocks has at least two first electrical connecting terminals for a respective one of the heating elements. Preferably, the connecting blocks are also provided for each of the thermal couple elements and each accommodate two second connecting terminals.

In accordance with another feature of the invention, the thermocouple elements are plate-shaped and are inserted generally in a middle of the multilayer press assembly. Each of the thermocouple elements is associated with at least one connecting block for accommodating two of the first and second connecting terminals.

In accordance with a further feature of the invention, the press has press plates; and the electrical contact connectors and/or the sensor connectors are disposed on at least one of the press plates. The electrical contact connectors and the sensor connectors correspond to the first and/or second connecting terminals and can be brought into contact with the first and second connecting terminals. Wherein the electrical contact connectors and/or the sensor connectors are at least partially in a form of tongue members which extend vertically in a manner such as to be able to compensate for possible height differences. Ideally, the electrical contact connectors and/or the sensor connectors are in a form of spring-loaded tongue members. The spring-loaded tongue members can be at least partly displaced in a horizontal direction with a compressive force.

In accordance with yet another feature according to the invention, opposing connecting blocks are provided. Each of the tools has associated with it a respective opposing connecting block which bears or accommodate respective electrical contact connectors and the sensor connectors. The opposing connecting blocks correspond to the connecting blocks. The opposing connecting blocks are disposed on or at the press plates at different heights and with the spring-loaded tongue members having different heights. The opposing connecting blocks correspond to the first and second connecting terminals of a respective tool and the thermocouple elements, such that contact between the first and second connecting terminals, and the electrical contact connectors and the sensor connectors, is enabled.

In accordance with an additional feature of the invention, a control unit is provided and that during a pressing and heating process current temperatures of the tools and/or temperatures inside the multilayer press assembly are measurable and measurements are sent to the control unit. The control unit has a microprocessor, and a heating of the multilayer press assembly is controllable over time in a manner such that essentially uniform heating of the multilayer press assembly is enabled.

In accordance with another further feature of the invention, the press has hydraulic actuators connected to and controlled by the control unit such that coordinated control of a heating and operation of the hydraulic actuators is enabled, such that at least for periods of time simultaneous heating and control of pressure forces which prevail in the press assembly configuration is enabled.

In accordance with the invention, each of the connecting blocks has three first electrical connecting terminals for a respective heating element, the three first electrical connecting terminals include a ground terminal.

Other features which are considered as characteristic for the invention are set forth in the appended claims.

Although the invention is illustrated and described herein as embodied in a pressing and heating system for pressing of a multilayer press assembly, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, side elevational view of a press assembly for arrangement in a press, wherewith tools are shown schematically as are thermocouple elements disposed in two multilayer press assemblies according to the invention;

FIG. 2A is a diagrammatic, side elevational view of the press assembly in a press viewed laterally, showing thermocouple elements disposed in the region of the tools;

FIG. 2B is a diagrammatic, perspective view of the arrangement of the press assembly and the tools in the press, with various thermocouple elements, and their connecting terminals and contact connectors;

FIG. 3 is a schematic lateral detail view, partially enlarged, of the arrangement of the press assembly disposed in a press, with the schematically shown connecting terminals of the thermocouple elements;

FIG. 4 is a graph showing a heating curve, intended to illustrate the control of an upper and lower tool in the press assembly;

FIG. 5 is a diagrammatic, perspective view of the press assembly disposed in the opening of a stacked press, showing the lower press plate but with omission of the upper press plate;

FIG. 6 is a diagrammatic, rear perspective view of the press assembly, showing the individual terminals but with omission of the opposing contact connectors in the press and with omission of the multilayer press assemblies between the individual tools;

FIG. 7 is a diagrammatic, perspective view of the lower press plate of the press, with the terminals and sensor contacts also being shown schematically; and

FIG. 8 is a diagrammatic, rear view of the press assembly configuration which has been pushed into the opening of a press, showing the three tools, but with omission of the multilayer press assemblies, and with omission of the upper press plate of the press thus showing only the lower press plate.

### DETAILED DESCRIPTION OF THE INVENTION

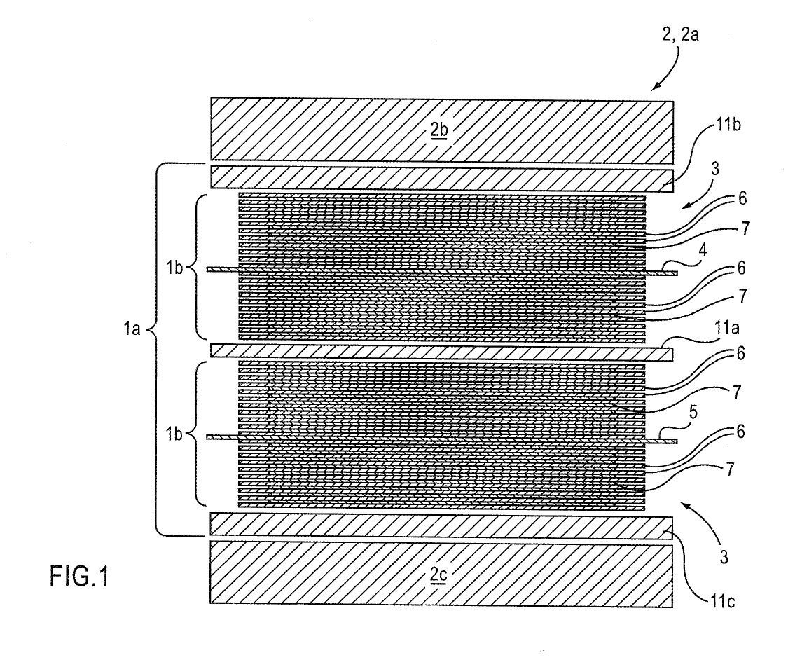

Referring now to the figures of the drawing in detail and first, particularly, to FIG. 1 thereof, there is shown at least partially a pressing and heating system for pressing of at least one multilayer press assembly 1b (two such assemblies 1b being shown here in a preferred embodiment), wherewith each multilayer press assembly 1b has a plurality of sets 7 of material each of which sets is formed of multiple layers of material to be pressed to form a multilayer printed circuit board or the like. At least one tool 11 is provided (here the three tools 11a, 11b, and 11c, in a preferred embodiment) which comes to be inserted in or pushed into an insertion opening 3 of a press 2 (here a stacked press 2a, in a preferred embodiment), wherewith the electrical configuration of the tool 11 (viz. the tools 11a, 11b, 11c) is such that each tool 11a, 11b, 11c is associated with or formed of at least one electrically powered heating element 10. A non-illustrated control unit for controlling the heating elements 10 is provided.

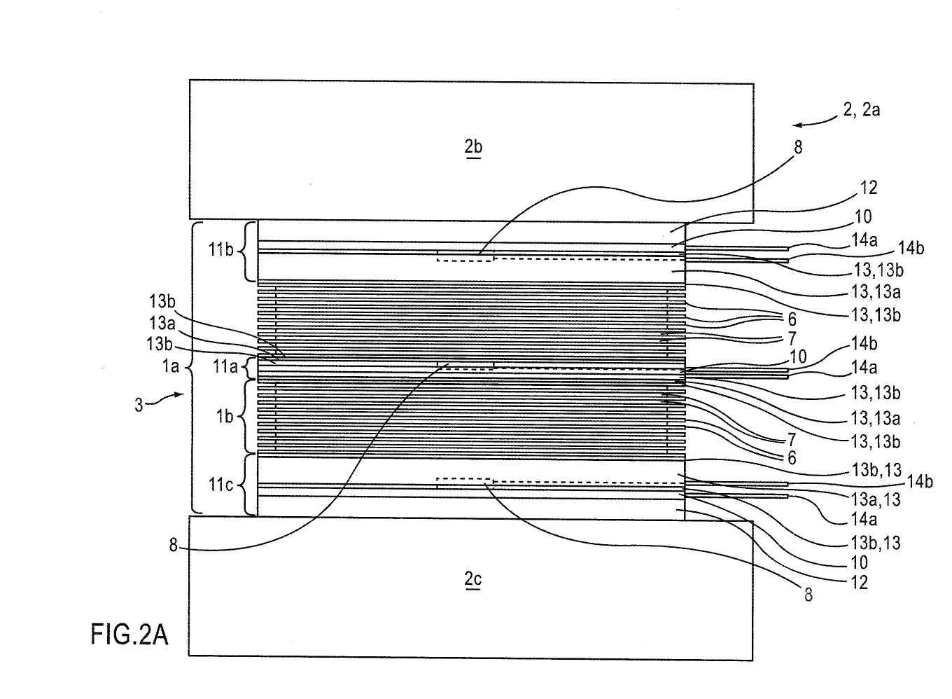

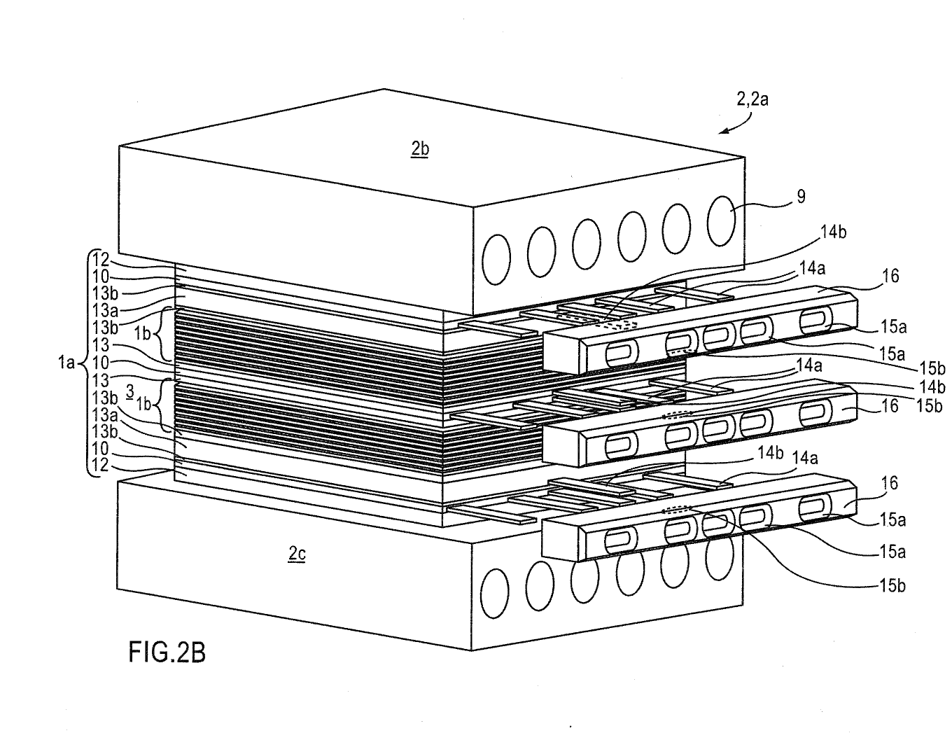

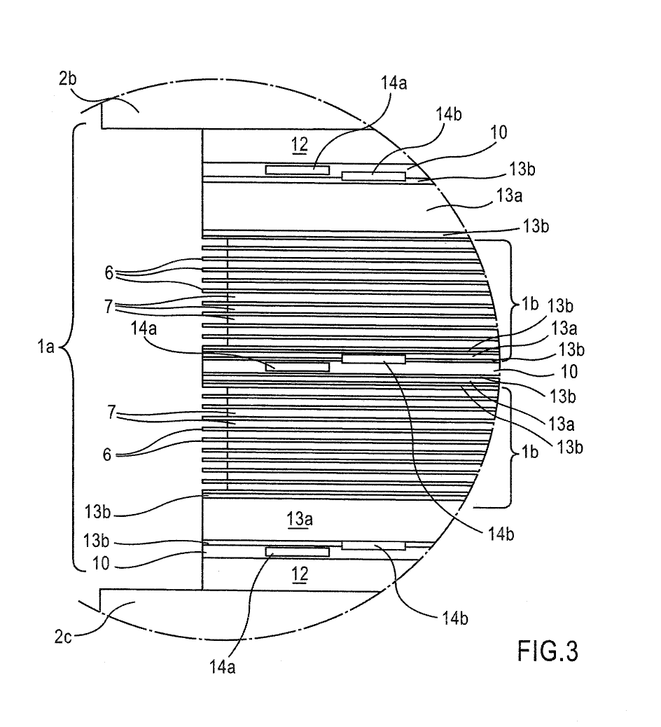

The described advantages are achieved in that at least one thermocouple or the like is provided (preferably two thermocouple elements 4, 5 (FIG. 1)). The thermocouple elements 4, 5 may be in the form of nickel-titanium elements, preferably partially of a plate-like shape, and preferably have cable-like ends which have connecting terminals 14b (described further hereinbelow). It is also possible that thermocouple elements 8 may be provided inside the tools 11a-11c, as illustrated schematically (e.g.) in FIGS. 2-3. Also possible is disposition of thermocouple elements in the multilayer press assembly (as illustrated in FIG. 1), possibly in addition to disposition inside the tools (e.g. thermocouple elements 8 in FIGS. 2A-3). These configurations will depend on the given application situation.

As seen in FIGS. 2A-3, each tool 11a, 11b, 11c preferably has a respective thermocouple element 8. The tools 11a, 11b, 11c are capable of being inserted in (pushed into) the opening 3 of the press 2. As seen in FIGS. 1-3, a central tool 11a, an upper tool 11b, and a lower tool 11c are provided. The upper tool 11b and lower tool 11c are each formed of a cover plate 12, a heat transfer plate (and/or heat conduction plate) 13, and a heating element 10 disposed between the plates 12 and 13. The middle tool 11a is formed of two heat transfer plates (and/or heat conduction plates) 13 and the heating element 10 disposed between the plates 13. The heat transfer and/or heat conduction plates 13 are specially constructed, with an aluminum core 13a and two outer plated alloy steel sheets 13b preferably in a thickness ratio of 80:20 (13a to 13b).

The heating elements 10 are in the form of flattish electrical heating bodies, with a special configuration, formed of electrical heating elements (and/or heating wires) which preferably are wound around associated elements; the heading bodies are provided between two micanite coatings. The micanite coatings serve as electrical insulators with respect to the thermal conduction plate 13 and the cover plate 12.

As seen from FIGS. 1-3, the upper and lower tools 11b, 11c are constructed and are disposable in relation to at least one multilayer press assembly 1b such that a press assembly configuration 1a is realized, namely at least the upper and lower tools 11b, 11c are insertable and usable as a press tool, in the opening of a press. Preferably, a third tool 11a is provided generally in the middle of the press assembly configuration 1a, to promote good heat distribution and optimal heating in the middle of the overall press assembly configuration 1a. The tools 11a, 11b, 11c are first fabricated as separated components, but when the press assembly configuration 1a is being set up they are interconnected, via suitable guide elements, particularly guide rods and/or the like, so that the overall press assembly configuration 1a can be readily inserted in the opening 3 of the press 2, and the upper and lower tools 11b, 11c can then be employed as pressing tools (or as part of a pressing tool set).

Also as seen from FIGS. 1-3, the heating elements 10 and tools 11a, 11b, 11c have first electrical connecting terminals 14a for connecting to corresponding contact connectors 15a of the press 2. The thermocouple elements 4, 5; 8 have associated second electrical connecting terminals 14b for connecting to corresponding sensor connectors 15b (sensor contact connectors) of the press 2. The first and/or second connecting terminals 14a; 14b may preferably be in the form of plug connectors, to facilitate mutual engagement of the connector elements when the press assembly configuration 1a is inserted into the opening 3 of the press 2.

Preferably, the press 2 is specially adapted to serve as part of the here illustrated pressing and heating system for pressing and fabrication of multilayer sets of material 7 for printed circuit boards or the like, namely for pressing of the multilayer press assemblies 1b. For this purpose, the press 2 has corresponding electrical contact connectors 15a for the respective heating elements 10 and tools 11a, 11b, 11c, and has corresponding sensor connectors 15b for the respective thermocouple elements 4, 5; 8.

Preferably the press 2 of the described type is in the form of a heatable vacuum press. The contact connectors 15a, 15b are thus preferably provided in one or more contact strips 16 disposed at a rear wall of the insertion opening 3 of the press 2.

The drawbacks described supra are further countered (alleviated) in that the first connecting terminals 14a and/or the associated contact connectors 15a are configured such that, when the tools 11a, 11b, 11c and/or the press assembly configuration 1a is/are inserted into the opening 3 of the press 2, the possible height difference between the first connecting terminals 14a and the associated contact connectors 15a can be automatically compensated for, to enable contacting of the terminals 14a with the connectors 15a.

The second connecting terminals 14b, of the thermocouple elements 4, 5; 8, may have corresponding sensor connectors 15b which generally correspond to the connecting terminals 14b, being constructed such that when the tools 11a, 11b, 11c and/or the press assembly configuration 1a is/are inserted into the opening 3 of the press 2, the possible height difference between the second connecting terminals 14b and the associated sensor connectors 15b can be automatically compensated for, to enable contacting of the terminals 14b with the connectors 15b.

It is possible that as a result of the layering and disposition, and/or other factors in the manufacturing, of the press assembly configuration 1a which is to be inserted in the opening 3 of the press 2, the press assembly configuration 1a will not always have a specific invariant height (which will depend inter alia on sandwiched separating plates 6 and multilayer sets of material 7 for printed circuit boards or the like; therefore, one cannot predict that the connecting terminals 14a, 14b will always be at the same height. Accordingly, the contact connectors 15a and sensor connectors 15b of the press 2 which serve as engaging parts to the terminals, while they will be disposed at specific locations in the press 2, will be specifically configured to accommodate (compensate for) such height variabilities at the time that the press assembly configuration 1a is inserted into the opening 3 of the press 2, so as to produce suitable contacting when the tools 11a, 11b, 11c are so inserted, even if the press assembly configuration 1a has any of the possible height variations.

One way to provide this accommodation is for the first and second connecting terminals 14a, 14b, and the contact connectors 15a and sensor connectors 15b, to be realized as sliding contact sets (e.g. so-called “wiping contacts”) which automatically adjust for height differences. In an embodiment of this, the first and second connecting terminals 14a, 14b, and the contact connectors 15a and sensor connectors 15b, have tapered regions, or have non-illustrated spring-loaded contact elements which serve to automatically compensate for height differences between the first and second connecting terminals 14a, 14b, on the one hand, and the contact connectors 15a and sensor connectors 15b, on the other hand. For reliability, spring-loaded contact elements are particularly useful.

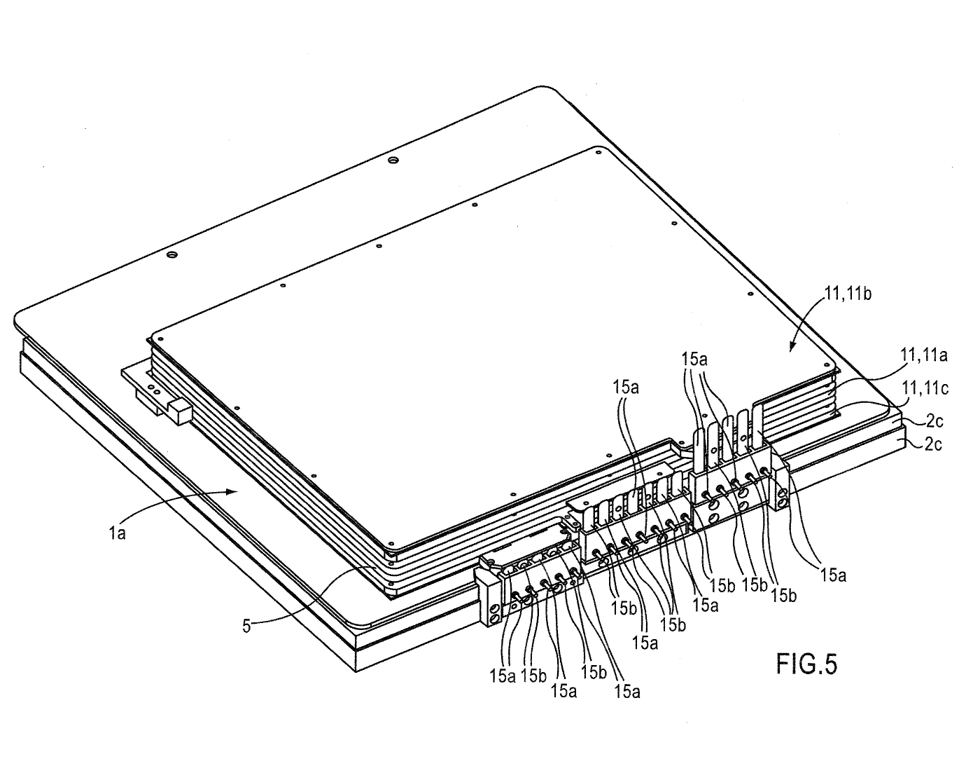

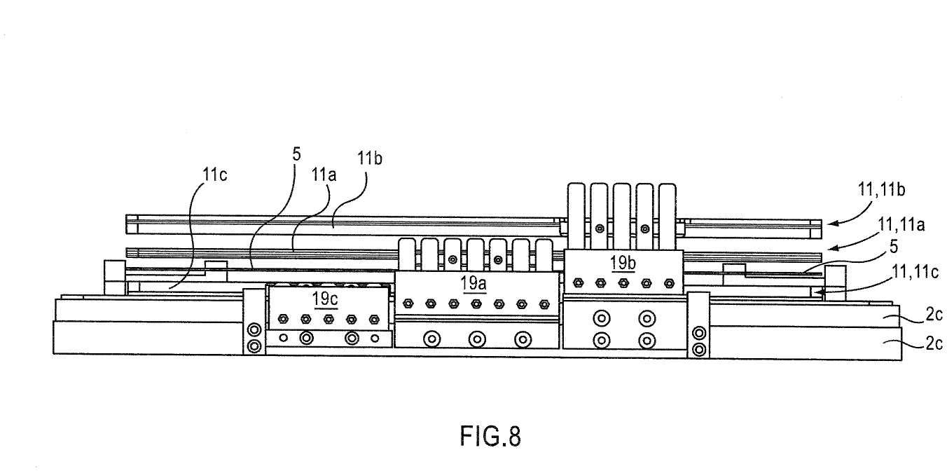

A preferred embodiment of the first and second connecting terminals 14a, 14b, and of the contact connectors 15a and sensor connectors 15b, is illustrated schematically in FIGS. 5-8.

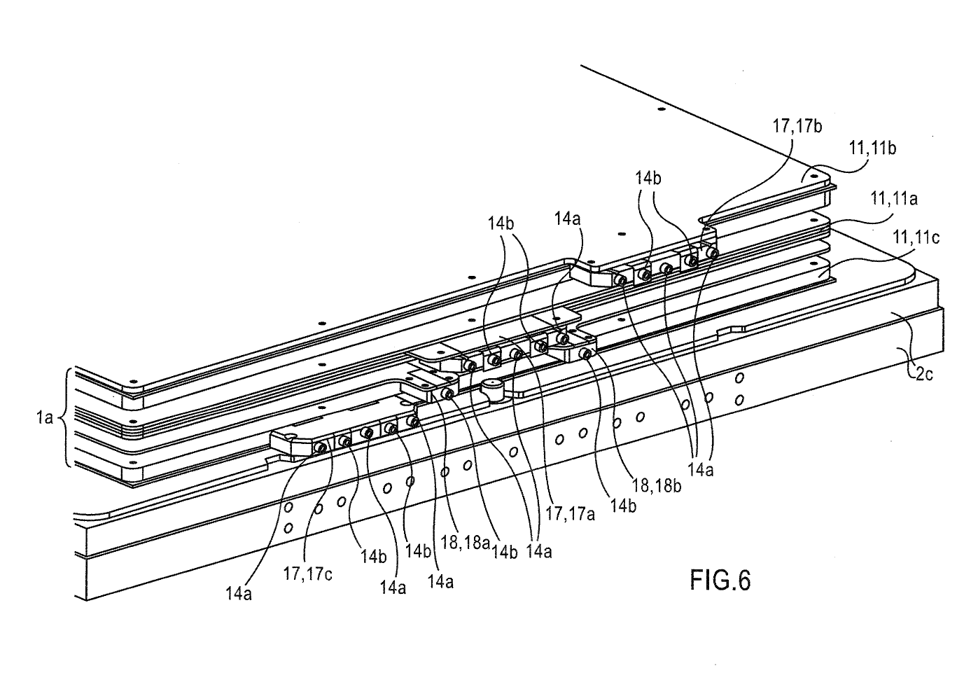

FIG. 6 shows schematically the press assembly configuration 1a with the individual tools 11a, 11b, 11c. The multilayer press assemblies 1b disposed between the tools 11a and 11b (and between the tools 11a and 11c) are not shown here. FIG. 6 clearly shows a contact point configuration of the first and/or second connecting terminals 14a, 14b, particularly a knob-like configuration. Each of the tools 11a, 11b, 11c has a respective connecting block 17a, 17b, 17c which accommodates the first and/or second connecting terminals 14a, 14b. FIG. 5 also provides a good illustration of this, in part.

The tool 11a is associated with the connecting block 17a, the tool 11b with the connecting block 17b, and the tool 11c with the connecting block 17c. Each connecting block 17a, 17b, 17c has associated connecting terminals 14a and 14b. In particular, for each heating element 10 of a given tool 11a, 11b, 11c, at least two first electrical connecting terminals 14a, preferably three first electrical connecting terminals 14a (including the neutral (or ground) terminal), are provided. This is particularly well illustrated in FIG. 6. Also, for each thermocouple element 8, the individual connecting blocks 17a, 17b, 17c each have two second connecting terminals 14b (also particularly well illustrated in FIG. 6.

The press assembly configuration 1a in FIGS. 5-8 does not include depiction of the multilayer press assemblies 1b between the tools 11a, 11b, 11c, but essentially only depiction of the individual tools 11a, 11b, 11c with the contacts and their opposite contacts (the latter being particularly well shown). The thermocouple elements 4, 5 which are illustrated in FIG. 1 are also accommodated, which thermocouple elements 4, 5 have generally flat shapes and can be disposed generally in the middle of a multilayer press assembly 1b. In the preferred embodiment, only one plate-like thermocouple element 5 is provided in the press assembly configuration 1a, namely in the lower multilayer press assembly 1b which commonly is disposed between the middle and lower tools 11a and 11c. The plate-like thermocouple element 5 has a connecting block 18, and preferably has two connecting blocks 18a, 18b, each with a second connecting terminal 14b—also well illustrated in FIG. 6.

As seen from FIGS. 5, 7, and 8, the press 2 has contact connectors 15a and sensor connectors 15b that correspond to the first and second connecting terminals 14a; 14b, which connectors 15a; 15b can be brought into compressive contact with the terminals 14a; 14b. These contact connectors 15a and sensor connectors 15b are preferably disposed on at least one of the press plates 2b or 2c of the press 2. It is possible, however, for the contact connectors 15a and sensor connectors 15b to be disposed on the side wall and/or rear wall of the press 2. The configuration will depend on the given application situation, and on the forms of the connecting terminals 14a, 14b on the tools 11.

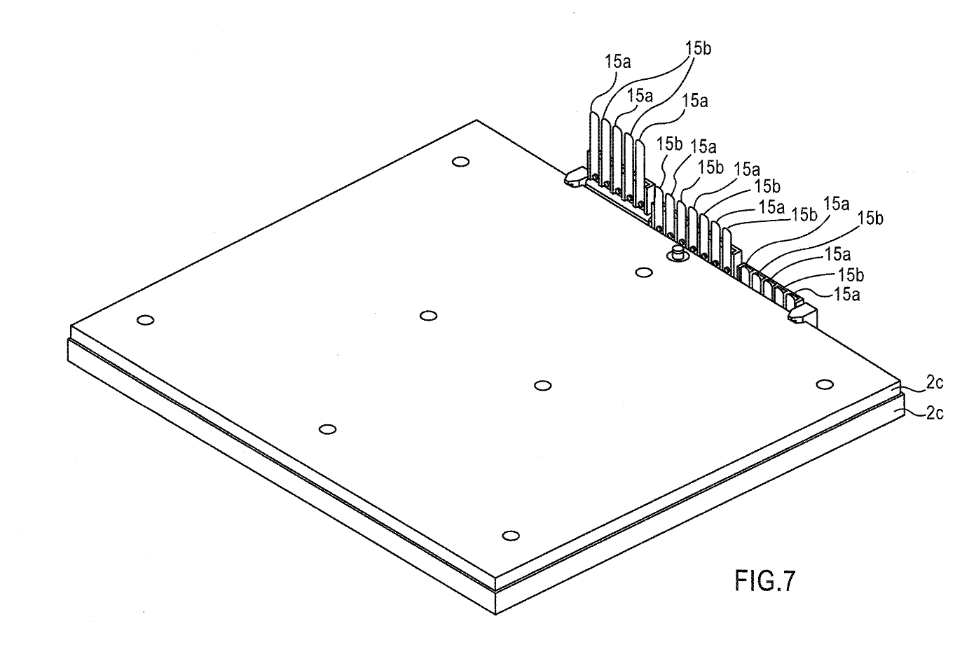

The form and disposition of the contact connectors 15a and sensor connectors 15b is readily seen from FIGS. 5, 7, and 8. In order to compensate for a possible height difference, these connectors 15a; 15b are at least partly in the form of tongue members which extend vertically (see especially FIG. 7, which shows only the connectors 15a; 15b associated with the lower press plate 2c of the press 2, in a front view, in the absence of the tools 11a, 11b, 11c which are to be inserted into the press. It is also well illustrated how the contact connectors 15a and sensor connectors 15b are in the form of spring-loaded tongue members (preferably formed of spring steel). The spring-loaded tongue members are fixed in connecting blocks 19a, 19b, 19c, via the lower ends of the tongue members, preferably with the aid of screw elements. The tongue members 15a; 15b and associated screw elements are not shown in pictorial detail; however, they are realized in a form such that the spring-loaded tongue members, particularly their upper ends, are mounted so as to be displaceable (e.g. slidable) at least partially in the horizontal direction, with a compressive force in the opposing connecting blocks 19a, 19b, 19c, as seen from FIGS. 5 and 7, in that the blocks 19a, 19b, 19c are configured to have corresponding recesses on the side and direction facing the tools 11a, 11b, 11c which enable such displaceability in the horizontal direction.

Thus, opposing connecting blocks 19a, 19b, 19c are provided which are opposed to the connecting blocks 17a, 17b, 17c of the tools 11a, 11b, 11c, which opposing blocks 19a, 19b, 19c are disposed on the press 2, preferably on one of the pressure plates 2b, 2c. The number of contact connectors 15a and sensor connectors 15b provided in the opposing connecting blocks 19a, 19b, 19c corresponds to the (number of) first and second connecting terminals 14a, 14b—which also is clearly seen from the figures. Preferably, the middle opposing connecting block 19a has two additional (outer) sensor connectors 15b, 15b for the second connecting terminals 14b of the thermocouple element 5, as seen particularly well from FIG. 5.

As clearly seen (however schematically) from FIGS. 5, 7, and 8, the opposing connecting blocks 19a, 19b, 19c are disposed on press plate 2c at essentially different heights and with different lengths, and the spring-loaded springs have corresponding different heights, so that the various contact connectors 15a and sensor connectors 15b which engage the first and second connecting terminals 14a; 14b of the respective tools 11a; 11b are continuously in good alignment. In particular, the lengths of the spring-loaded tongue members are such that height differences (tolerances) which can arise as a result of, e.g., the makeup of the press assembly configuration 1a can be compensated for, particularly so as to provide a good contact between the respective contact elements, even in the event of variations in the press assembly arrangements 1a, in particular because the lengths of the spring-loaded tongue members are such as to accommodate the tolerances. Preferably, the press 2 is in the form of a stacked press with a plurality of openings 3 (so-called “stages”, or “levels”), with contact connectors 15a and sensor connectors 15b being disposed at each stage (or level) of the stack.

During the pressing and heating process, the current temperatures of the tools 11a, 11b, 11c are measured, and/or the temperatures inside the multilayer press assembly 1 are measured, and the measurements are forwarded to the non-illustrated control unit. Preferably, the control unit has a microprocessor, and the timewise heating of the multilayer press assembly 1b is controllable so as to enable uniform heating of the “book” and of the multilayer press assembly 1b.

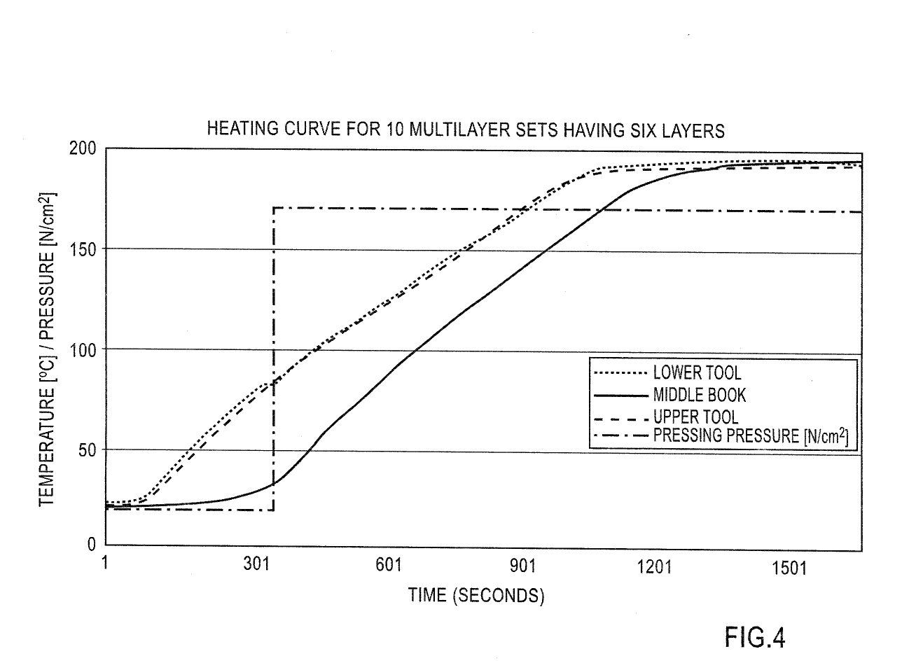

FIG. 4 shows a representative heating curve, e.g. for ten multilayer sets of material having six layers (for fabrication of printed circuit boards or the like), namely the heating of a lower and upper tool in a press assembly and the heating of the book in the middle, versus time (in seconds) (with the temperature as well as pressure being plotted on the vertical axis). It is seen that the lower and upper tools 11b, 11c are heated essentially equally, and it is seen how the book in the middle is heated with a regular lag after the tools. Also readily seen is that, beginning at a certain time, here preferably after five minutes, the pressing process is started, with the relevant pressing pressure being applied in the press 2.

Accordingly, the control unit is configured such that the hydraulic actuators of the press are controllable depending on the course of the temperature inside the press assembly configuration 1a, enabling a coordinated form of simultaneous control of both the heating and the application of the hydraulic actuators (control of the pressing force), so that, at least for a period of time (as illustrated in FIG. 4), one can carry out heating and can simultaneously adjust the pressure. This saves energy (and thus energy-related costs), shortens the operating time, and reduces the operating costs, for fabricating the multilayer products (printed circuit boards or the like), in a decisively advantageous manner. Controlled supply of energy is enabled, as is quality control during the pressing process, in particular via the plotting and evaluation of the heating curve.

Finally, old presses that have, e.g., channels 9, can be easily and quickly retrofitted to utilize the inventive pressing and heating system.

1. A pressing and heating system for pressing of a multilayer press assembly, the multilayer press assembly having a plurality of multilayer sets of material being mutually separated by at least one separating plate, the pressing and heating system comprising:
a stacked press having an insertion opening formed therein;
at least one electrically powered heating element;
at least one tool for being inserted into said insertion opening of said stacked press, said tool being electrically heatable by said at least one electrically powered heating element;
a control unit for controlling said heating element; and
at least one thermocouple element.

2. The pressing and heating system according to claim 1, wherein said thermocouple element is disposed inside said tool.

3. The pressing and heating system according to claim 1, wherein:
said thermocouple element is one of at least three thermocouple elements; and
said tool is one of three tools that are insertable into said insertion opening of said stacked press, and each of said tools has a respective one of said thermocouple elements.

4. The pressing and heating system according to claim 1, wherein said tool includes a cover plate, a heat transfer plate and said heating element disposed between said cover plate and said heat transfer plate.

5. The pressing and heating system according to claim 1, wherein said heating element is a flattish heating body with a micanite coating on at least two sides.

6. The pressing and heating system according to claim 3, wherein said three tools define a press assembly configuration having an upper tool and a lower tool constructed and disposable in relation to the at least one multilayer press assembly, at least said upper and lower tools are capable of being inserted and utilized in said insertion opening of said stacked press, said press assembly configuration further includes a middle tool disposed generally in a middle of said press assembly configuration.

7. The pressing and heating system according to claim 1, wherein said thermocouple element is disposed in the multilayer press assembly.

8. The pressing and heating system according to claim 3, wherein:
said heating element is one of three heating elements and each of said heating elements is part of one of said tools;
said stacked press has first contact connectors and second sensor connectors;
at least one of said heating elements and said tools have first electrical connecting terminals for connecting with corresponding ones of said first contact connectors of said stacked press; and
said thermocouple elements have corresponding second connecting terminals for connecting with corresponding ones of said second sensor connectors of said stacked press.

9. The pressing and heating system according to claim 8, wherein at least one of said first and second connecting terminals are plug connectors.

10. The pressing and heating system according to claim 1, wherein said tool includes two heat transfer plates and said heating element is disposed between said two heat transfer plates.

11. A pressing and heating system for pressing at least one multilayer press assembly formed of multilayer sets of material, the pressing and heating system comprising:
a press assembly configuration containing electrically heatable tools having first connecting terminals;
heating elements having first connecting terminals; and
a press for at least one of pressing and fabricating the at least one multilayer press assembly, said press having an opening formed therein in for allowing insertion of the multilayer press assembly and insertion of said electrically heatable tools, said press having electrical contact connectors for receiving said first connecting terminals of one of a given one of said heating elements and a given one of said tools, at least one of said first connecting terminals and said electrical contact connectors are configured such that, when at least one of said tools or said press assembly configuration is inserted into said opening of said press, a possible difference in height between said first connecting terminals and said electrical contact connectors can be automatically compensated for, so that said first connecting terminals can be contacted with said electrical contact connectors.

12. The pressing and heating system according to claim 11,
further comprising thermocouple elements having second connecting terminals; and
wherein said press has sensor connectors each provided for a corresponding one of said thermocouple elements, said second connecting terminals and corresponding ones of said sensor connectors are configured such that, when at least one of said tools and said press assembly configuration is inserted in said opening of said press, a possible difference in height between said second connecting terminals and said sensor connectors can be automatically compensated for, so that said second connecting terminals can be contacted with said sensor connectors.

13. The pressing and heating system according to claim 11, wherein at least one of said electrical contact connectors and said sensor connectors are realizable in a contact strip.

14. The pressing and heating system according to claim 13, wherein at least one of said electrical contact connectors, said sensor connectors and said contact strip is disposed at a rear wall of said opening of said press.

15. The pressing and heating system according to claim 12, wherein said first and second connecting terminals, said electrical contact connectors and said sensor connectors are in the form of sliding contact sets which automatically compensate for height differences.

16. The pressing and heating system according to claim 12, wherein said first and second connecting terminals, said electrical contact connectors and said sensor connectors have at least one of at least partly tapered regions and spring-loaded contact elements, for automatic compensation for possible height differences between said first and second connecting terminals, and said electrical contact connectors and said sensor connectors.

17. The pressing and heating system according to claim 12, wherein at least one of said first and second connecting terminals have a contact point configuration.

18. The pressing and heating system according to claim 12, wherein each of said tools has a connecting block for bearing and accommodating at least one of said first and second connecting terminals.

19. The pressing and heating system according to claim 18, wherein each of said connecting blocks has at least two said first electrical connecting terminals for a respective one of said heating elements.

20. The pressing and heating system according to claim 18, wherein said connecting blocks are also provided for each of said thermal couple elements and each accommodate two of said second connecting terminals.

21. The pressing and heating system according to claim 18, wherein said thermocouple elements are plate-shaped and are inserted generally in a middle of the multilayer press assembly, each of said thermocouple elements is associated with at least one said connecting block for accommodating two of said first and second connecting terminals.

22. The pressing and heating system according to claim 18, wherein:
said press has press plates; and
at least one of said electrical contact connectors and said sensor connectors are disposed on at least one of said press plates, said electrical contact connectors and said sensor connectors correspond to at least one of said first and second connecting terminals and can be brought into contact with said first and second connecting terminals.

23. The pressing and heating system according to claim 12, wherein at least one of said electrical contact connectors and said sensor connectors are at least partially in a form of tongue members which extend vertically in a manner such as to be able to compensate for possible height differences.

24. The pressing and heating system according to claim 22, wherein at least one of said electrical contact connectors and said sensor connectors are in a form of spring-loaded tongue members.

25. The pressing and heating system according to claim 24, wherein said spring-loaded tongue members can be at least partly displaced in a horizontal direction with a compressive force.

26. The pressing and heating system according to claim 24, further comprising opposing connecting blocks, each of said tools has associated with it a respective one of said opposing connecting blocks which bear or accommodate respective ones of said electrical contact connectors and said sensor connectors, said opposing connecting blocks correspond to said connecting blocks.

27. The pressing and heating system according to claim 26, wherein said opposing connecting blocks are disposed on or at said press plates at different heights and with said spring-loaded tongue members having different heights, said opposing connecting blocks corresponding to at least one of said first and second connecting terminals of a respective one of said tools and said thermocouple elements, such that contact between said first and second connecting terminals, and said electrical contact connectors and said sensor connectors, is enabled.

28. The pressing and heating system according to claim 12, further comprising a control unit and that during a pressing and heating process at least one of current temperatures of said tools and temperatures inside said multilayer press assembly are measurable and measurements are sent to said control unit.

29. The pressing and heating system according to claim 28, wherein said control unit has a microprocessor, and a heating of the multilayer press assembly is controllable over time in a manner such that essentially uniform heating of the multilayer press assembly is enabled.

30. The pressing and heating system according to claim 28, wherein said press has hydraulic actuators connected to and controlled by said control unit such that coordinated control of a heating and operation of said hydraulic actuators is enabled, such that at least for periods of time simultaneous heating and control of pressure forces which prevail in said press assembly configuration is enabled.

31. The pressing and heating system according to claim 11, wherein said contact point configuration is a knob-shaped configuration.

32. The pressing and heating system according to claim 18, wherein each of said connecting blocks has three first electrical connecting terminals for a respective one of said heating elements, said three first electrical connecting terminals include a ground terminal.

33. The pressing and heating system according to claim 21, wherein each of said thermocouple elements is associated with two of said connecting blocks.

34. The pressing and heating system according to claim 22, wherein said first and second connecting terminals can be brought into compressive contact with said first and second connecting terminals.

35. The pressing and heating system according to claim 24, wherein at least one of said electrical contact connectors and said sensor connectors is formed from spring steel.
